(19) United States
(12) Patent Application Publication
(10) Pub. No.: US 2024/0414538 A1
(43) Pub. Date: Dec. 12, 2024

(54) SYSTEM AND METHODS FOR ENABLING ULTRA-WIDE BAND IN PASSIVE DEVICES

(71) Applicant: VISA INTERNATIONAL SERVICE ASSOCIATION, SAN FRANCISCO, CA (US)

(72) Inventors: Mustafa Top, San Ramon, CA (US); Yuexi Chen, Foster City, CA (US)

(73) Assignee: VISA INTERNATIONAL SERVICE ASSOCIATION, SAN FRANCISCO, CA (US)

(21) Appl. No.: 18/694,886

(22) PCT Filed: Sep. 24, 2021
(86) PCT No.: PCT/US2021/051993

§ 371 Date: Mar. 22, 2024

(51) Int. Cl. H04W 12/08; H04W 12/63

(52) U.S. Cl. CPC H04W 12/08; H04W 12/63

(57) ABSTRACT

Techniques for enabling usage of an Ultra-Wideband (UWB) chip on a passive device are disclosed. The passive device comprises a substrate including a first electronic component, and a second electronic component. The first electronic component is programmed to communicate with an access device using a first communication protocol, and the second electronic component is programmed to communicate with the access device using a second wireless communication protocol. The passive device includes a first antenna electrically coupled to at least the first electronic component or the second electronic component, and a second antenna electrically coupled to at least the second electronic component. The first antenna is adapted to receive a first signal from the access device, which powers at least the second electronic component, thereby causing the second electronic component to cause the second antenna to emit a second signal that is received by the access device.

### CROSS REFERENCE TO RELATED APPLICATIONS

None.

### BACKGROUND

There are a variety of applications where two devices perform a short range data transfer using radio technology. As an example, a person can use a smart card (communicating with a smart card reader) to access a secure building. As another example, a person can use a smart card (communicating with a smart card reader) to perform a payment transaction. In a legitimate use case, this data transfer is intentional (i.e., the data transfer is initiated by the owners or operators of the devices) and the two devices are in relatively close proximity (i.e., on the order of meters, centimeters, or millimeters, rather than kilometers).

Communications such as these can have data security issues. For example, in a relay attack, the smart card and the smart card reader can communicate unintentionally and over long distances. A fraudster (or team of fraudsters) can establish a communication relay between the two devices, inducing them to communicate even though they are not proximate. For example, a first fraudster can place a first radio communication device in close proximity to a legitimate user's smart card (e.g., by placing the first radio communication device next to the user's wallet containing the smart card) and a second fraudster can place a second radio communication device next to the card reader. The first radio communication device and the second radio communication device can relay communications between the smart card and the card reader, potentially causing the card reader to unlock the door to the secure building or conduct a payment transaction, even though an authorized user is not present. Such fraudulent use can have consequences. Fraudsters can perform attacks such as relay attacks in order to impersonate people, gain unauthorized access to secure facilities, steal money, etc. Thus, there is a need for secure (and relay attack resistant) methods and systems for securing data transfers, particularly during short distance radio communications.

Embodiments described herein address these and other problems, individually and collectively.

### SUMMARY

Embodiments of the present disclosure are directed to methods and systems for enabling usage of an Ultra-Wideband (UWB) chip on a passive device. Embodiments can be used to prevent fraudsters from performing fraudulent data transfers between passive devices operated by users (e.g., contactless cards, smart cards, key fobs) and access devices (e.g., point of sale (POS) terminals, building access control systems, etc.) using relay attacks.

Some embodiments can use features of ultra-wideband (UWB) communication protocols (defined by IEEE standards 802.15.4 and 802.15.4z) in order to accurately determine the distance between a passive device (operated by a user) and an access device or terminal. This distance measurement can be used to determine if the passive device is actually present at an access device (as expected during a legitimate data transfer) or if the passive device is far away from an access device (as expected during a relay attack).

After a passive device enters a “destination area” (a defined region of space, in some cases proximate to the access device), the passive device and an access device can initiate a UWB ranging protocol in order to determine the distance between the passive device and the access device, producing a distance measurement. This distance measurement, along with any other relevant information, such as device identifiers, can be used by the devices (e.g., the access device, and/or the passive device) to determine whether the passive device is relatively close to the access device or is far away from the access device. If the passive device is close to the access device it is unlikely a relay attack is taking place. If the passive device is far from the access device there is a reasonable chance that a relay attack is taking place.

If the passive device is not present (e.g., the distance measurement exceeds some threshold), the passive device and/or the access device can abort the data transfer i.e., the transaction. Alternatively, the passive device and access device can complete the data transfer, but abort or otherwise terminate some subsequent action that takes place as a result of the data transfer.

For example, after a passive device transfers an access token to a building control access device during a data transfer, the building control access device can unlock an electronically locked door. If the building control access device determines that the passive device is not actually present at the building control access device, the passive device and building control access device could still complete the data transfer, but the building control access device could simply not open the locked door. This could be useful if for example, the building control access device uses the access token to determine the identity of the corresponding user, so that the user can be contacted and informed of suspicious use of their access credentials.

As another example, a passive device (e.g., a contactless card) can transmit a payment credential, such as a payment account number (PAN), to an access device as part of a transaction between the user of the passive device and a merchant operator of the access device. If the access device (or another downstream entity) determines that the passive device is far away from the access device, the access device can abort the rest of the payment process (e.g., transferring an authorization request message to an issuing bank via a payment processing network, such as VisaNet™). Alternatively, the access device can include the distance measurement (and other relevant information) in an authorization request message, enabling the payment processing network and/or an issuing bank to perform their own risk analysis and potentially deny the transaction.

In both examples, there is an incentive for a fraudster or team of fraudsters to use relay attacks. In the first case, a fraudster could use a relay attack in order to gain access to a space that they are unauthorized to access (such as a secure government facility). In the second case, a fraudster could use a relay attack in order to make a purchase using funds belonging to another individual (effectively stealing money from that other individual). However, by using UWB to determine a distance measurement, devices participating in the data transfer can determine if a relay attack is taking place. Further because of some properties of UWB communication (including the use of narrow pulses with a high pulse repetition frequency and good time domain resolution), a fraudster cannot convincingly intercept and modify communications (including distance measurements) in order to defeat the distance measurement system. As such, embodiments of the present disclosure enable secure, relay attack resistant data transfers.

One embodiment is directed to a passive device comprising: a substrate; a first electronic component on the substrate, the first electronic component programmed to communicate with an access device using a first wireless communication protocol in a first frequency range; a second electronic component on the substrate programmed to communicate with the access device using a second wireless communication protocol in a second frequency range different than the first frequency range; a first antenna electrically coupled to at least the first electronic component or the second electronic component; and a second antenna electrically coupled to at least the second electronic component, wherein the first antenna is adapted to receive a first signal from the access device, which powers at least the second electronic component, thereby causing the second electronic component to cause the second antenna to emit a second signal that is received by the access device.

Another embodiment is directed to a method involving a passive device, the passive device comprising a first electronic component and a second electronic component on a substrate, a first antenna electrically coupled to at least the first electronic component or the second electronic component, and a second antenna electrically coupled to at least the second electronic component, the method comprising: communicating, by the first electronic component, with an access device using a first wireless communication protocol in a first frequency range; triggering by the first electronic component, the second electronic component of the passive device to communicate with the access device using a second wireless communication protocol in a second frequency range, the second frequency range being different than the first frequency range; receiving, by the first antenna, a first signal from the access device, the first signal powering at least the second electronic component; and causing, the second electronic component to cause the second antenna to emit a second signal that is received by the access device.

Another embodiment is directed to a method conducting by an access device that communicates with a passive device, the passive device comprising passive device comprising a substrate, a first electronic component on the substrate, a second electronic component on the substrate, a first antenna electrically coupled to at least the first electronic component or the second electronic component; and a second antenna electrically coupled to at least the second electronic component, the method comprising: transmitting, by the access device to the first antenna of the passive device, a first signal in a first wireless communications protocol, wherein the first signal powers at least the second electronic component, thereby causing the second electronic component to cause the second antenna to emit a second signal in a second wireless communications protocol; and receiving, by the access device, the second signal in the second wireless communications protocol.

These and other embodiments of the disclosure are described in detail below.

Prior to discussing specific embodiments of the present disclosure, some terms may be described in detail.

### TERMS

A “memory” may be any suitable device or devices that may store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

An “application” may include any computer program that is used for a specific purpose.

A “user” may include any user of some object or service. This may include, for example, a user of a “passive device” such as a contactless card i.e., a payment card such as a credit or debit card. A user may be associated with one or more personal accounts (e.g., payment accounts) or user devices. A user may be referred to as a “cardholder” (when possessing or using a payment card), an account holder (when possessing or using an account), or a consumer (when using goods or services provided by relying entities and resource providers).

A “resource provider” may include any suitable entity that provides resources (e.g., goods, services, access to secure data, access to locations, or the like) to other entities, such as users. For example, a resource providing entity can be a merchant, a venue operator, a building owner, a governmental entity, etc. A “merchant” may be an entity that engages in transactions and can sell goods or services, or provide access to goods or services.

An “access device” may include any suitable device for providing access to an external computer system. An access device may be in any suitable form. Some examples of access devices include point-of-sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a mobile device.

An “identifier” may include data used to identify something. This may include an object, entity (such as a person or business entity), computer system, transaction, method, etc.

A “token” may be a substitute value for a credential. An “access token” may be a token used to access something. A token may be a string of numbers, letters, or any other suitable characters. Examples of access tokens include digital wallet tokens (substituting for a digital wallet credential), virtual payment account numbers (VPANs), personal identification tokens, etc.

A “digital signature” may include any electronic signature for a message. A digital signature may be a numeric data value, an alphanumeric data value, or any other type of data. In some embodiments, a digital signature may be a unique data value generated from a message (or data packet) and a private key using a cryptographic algorithm. In some embodiments, a validation algorithm using a public key may be used to verify the signature. A digital signature may be used to demonstrate the veracity of the sender.

A “cryptogram” may include any packet of encrypted data. A cryptogram may be used to securely transmit sensitive data (such as transaction data or interaction data) through a public network such as the Internet or wirelessly using radio technology (such as Bluetooth®, near field communication (NFC), etc.).

A “frame” may include a unit of data in a data transmission in a computer network. In some embodiments, a “frame” can be any unit of data transmitted in the physical layer or the data link layer in the seven-layer OSI model of computer networking. A frame may comprise a self-contained independent entity of data containing sufficient information to be routed from a source device to a destination device. A frame can be transmitted wirelessly using technologies such as, for example, Wi-Fi™, Bluetooth®, NFC, etc.

An “acquirer” may include an entity that processes payments on behalf of a resource provider, such as a merchant. An acquirer may comprise a financial institution, such as a bank, that maintains an account for a merchant. An acquirer may operate an “acquirer computer,” a computer system that can be used to transmit payment information through networks such as the Internet, including, for example, authorization request messages and authorization response messages.

An “issuer” may include an entity that processes payments on behalf of a user, such as a consumer. An issuer may comprise a financial institution, such as a bank, that maintains an account for the user. An issuer may operate an “issuer computer,” a computer system that can be used to transmit payment information through networks such as payment processing networks and/or the Internet, including, for example, authorization request messages and authorization response messages.

An “authorization computer” may include any computer system that performs functions associated with authorizing certain actions. For example, an authorization computer may authorize transactions between customers and merchants. An authorization computer may be operated by an “authorizing entity.” An authorization computer can be an issuer computer.

A “processing network computer” may include a system that can support and deliver data services. A processing network computer can be in a “payment processing network” that may include data processing subsystems, networks, server computers and operations used to support and deliver authorization services, exception file services, and clearing and settlement services. A payment processing network may be any suitable network able to transmit and receive financial system transaction messages (e.g., ISO 8583 messages), and process original credit and debit card transactions. An exemplary payment processing system may include VisaNet™ Payment processing systems such as VisaNet™ are able to process credit card transactions, debit card transactions, and other types of commercial transactions.

“Transaction data” may include any data that is associated with a payment transaction. Transaction data may include a transaction amount, a date of a transaction, a primary account number associated with a user initiating the transaction.

“Authentication data” may include any data suitable for verifying something. Authentication data may include data authenticating a user or a mobile device. Authentication data may be obtained from a user or a device that is operated by the user. Examples of authentication data obtained from a user may include PINS (personal identification numbers), biometric data, passwords, etc. Examples of authentication data that may be obtained from a device may be include device serial numbers, hardware secure element identifiers, device fingerprints, phone numbers, IMEI numbers, etc.

An “authorization request message” may include any electronic message that requests authorization for a transaction. An authorization request message can be sent to a transaction processing computer, authorization computer, or issuer computer (associated with an issuer of a payment card) to request authorization for a transaction. An authorization request message can comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may include any electronic message that responds to an authorization request. In some cases, an authorization request message may comprise an electronic message reply to an authorization request message, and may be generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. PA equipment) that indicates approval of the transaction. The code can serve as proof of authorization.

### BRIEF DESCRIPTION OF THE DRAWINGS

FIG. 1A shows an exemplary passive device according to some embodiments.

FIG. 1B shows another exemplary passive device according to some embodiments.

FIG. 2 shows a block diagram of a passive device according to some embodiments.

FIG. 3 shows a system diagram illustrating interactions between a passive device and an access device according to some embodiments.

FIG. 4 shows a system block diagram of an exemplary passive device according to some embodiments.

FIG. 5 shows a system block diagram of an exemplary access device according to some embodiments.

FIG. 6 shows a sequence diagram illustrating interactions between a passive device and an access device according to some embodiments.

### DETAILED DESCRIPTION

Embodiments of the present disclosure provide for a framework to power an ultra-wideband (UWB) chip included in a passive device e.g., a contactless card, by harvesting power from an RF field of an access device e.g., a POS device. As such, the UWB chip can powered without a need for a battery to be included in the passive device. The UWB chip can be used for performing a distance measurement between the passive device and the access device. Such a distance measurement can be used to verify whether the passive device is present at an access device during or prior to a data transfer between the passive device and the access device. As will be described in detail, by some embodiments, the access device may also be configured to include a UWB chip that enables the access device to perform distance measurements. Such distance measurements can enable the access device and/or the passive device to determine whether the data transfer is legitimate or fraudulent. The data transfer can be terminated (or not acted upon) if the passive device is determined to be not present at or near the access device.

To determine if the passive device is present or likely present, embodiments can make use of wireless ranging techniques. Although wireless ranging can be performed with many different wireless technologies (e.g., radar, sonar, etc.), embodiments use UWB technology and ranging protocols, as defined in IEEE standards 802.15.4 and 802.15.4z. Prior to describing systems and methods according to embodiments, some characteristics of UWB are described below.

UWB is a wireless communication technology characterized by short-range, high bandwidth communications. UWB has good time domain resolution because of its high bandwidth. As a result of this good time domain resolution, UWB can be used to accurately determine the distance between objects, more accurately than other wireless technologies with lower bandwidth. As an example, some UWB Doppler radar systems can detect millimeter scale movement of objects at distances of around five meters.

UWB also supports higher pulse repetition frequencies (PRFs) compared to other wireless technologies. Generally, the pulse repetition frequency relates to the rate at which UWB-capable devices transmit pulses. In one UWB mode, devices can transmit at a PRF of 128 MHz, using 16 pulses per coded bit and a 4 ns spacing. As a result, the length of UWB bursts in this mode is approximately 32 ns.

These features make UWB technology well suited for applications related to securing data using distance measurements, as described herein. The good time domain resolution enables accurate ranging, enabling embodiments to accurately determine whether a device e.g., a contactless card is actually present during a transaction. Further, the nanosecond scale bursts and high pulse repetition make it difficult for any potential hacker to intercept and modify UWB frames. A hacker only has tens of nanoseconds to intercept, process, and transmit modified frames. This is a difficult or impossible task for current processing systems.

UWB ranging can be accomplished using techniques similar to those of other radio ranging technologies, e.g., using time of flight (ToF) measurements. Because the speed of light and the velocity factor of most transmission mediums (usually air for UWB) are known, the distance between two objects can be determine based on the amount of time it takes for one radio pulse to move from one object to the other.

For example, an access device can transmit a frame to a passive device. When the passive device receives the frame, the passive device can process or interpret the frame, then transmit a response frame back to the access device. The response frame can include or otherwise communicate a processing delay t_{process}, corresponding to the amount of time between when the passive device received the frame and when the passive device transmitted the response frame.

Using the processing delay t_{process} and the total time tₜₒₜₐₗ between when the access device transmitted the frame to the passive device and when the access device received the response frame, the access device can determine the time of flight t_{flight}. Because a pulse travels from the access device to the passive device, and another pulse travels from the passive device to the access device, the difference between tₜₒₜₐₗ and t_{process} is equal to twice the time of flight t_{flight}, and thus the time of flight can be determined using the following equation t_{flight}=0.5(tₜₒₜₐₗ−t_{process}). The access device can transmit another frame to the passive device with its own processing delay, thereby enabling the passive device to also calculate t_{flight}.

Both devices can then use the time of flight to calculate the distance between the access device and the passive device using, for example, d=vf·c·t_{flight}, where d is the distance, vf is the velocity factor and c is the speed of light in a vacuum. There are a number of variations on this technique that may become apparent to one skilled in the art. For example, timestamps could be used in place of delay values, multiple times of flight could be calculated and averaged, and/or additional terms could be introduced to improve accuracy or otherwise compensate for any issues that might be caused by the radio transmission environment (e.g., multipath interference).

The above described distance measurements performed by the passive device and/or the access device may be used in a wide range of applications to detect and prevent relay attacks or man-in-the middle attacks. For example, the access device may process interactions (e.g., transactions) and/or grant a user of a passive device access to something (for example, a good or service, access to a restricted area, etc.). In commercial applications, the access device may correspond a POS terminal. The access device can use a Bluetooth® transceiver or NFC transceiver to receive data (including, for example, payment data) from the passive devices e.g., contactless card. The access device can use data such as distance measurements and random identifiers to determine whether the passive device is present during the data transfer. Further details on relay attacks and ultra wideband communications can be found in PCT/US2021/040898 filed on Jul. 8, 2021, which is assigned to the same assignee as the present application.

In some embodiments, particularly those where authorization for some interaction is performed off-site, the access device may communicate with a processing network computer and an authorization computer. For instance, if the access device is a POS terminal, the processing network computer could comprise part of a payment processing network, and the authorization computer could comprise a computer system associated with an issuing bank that maintains a financial account for a user. In this case, the access device can generate an authorization request message, an electronic message that request authorization to complete a transaction. The authorization request message may include payment information such as a payment credential, as well as other information, such as distance measurements, identifiers, etc. The access device can transmit the authorization request message to the processing network computer, which can subsequently forward the authorization request message to the authorization computer.

The authorization computer can evaluate the authorization request message in order to determine whether or not to authorize the transaction. For example, by some embodiments, the authorization computer can authorize the transaction based on distance measurements performed by the access device. Specifically, the access device can perform some form of risk analysis e.g., by verifying that a distance measurement between the access device and the passive device (i.e., contactless card) is less than a threshold value in order to determine whether the transaction. Is to be authorized. The authorization computer can generate an authorization response message, indicating whether the transaction is authorized (or declined), then transmit the authorization response message to the processing network computer. The processing network computer can subsequently route the authorization response message back to the access device, enabling the access device, or an operator of the access device to complete the transaction.

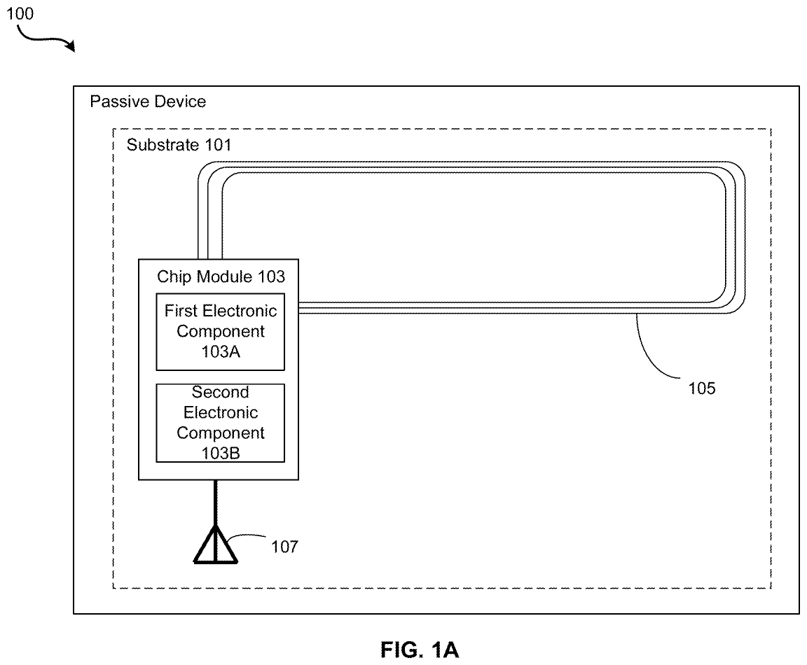

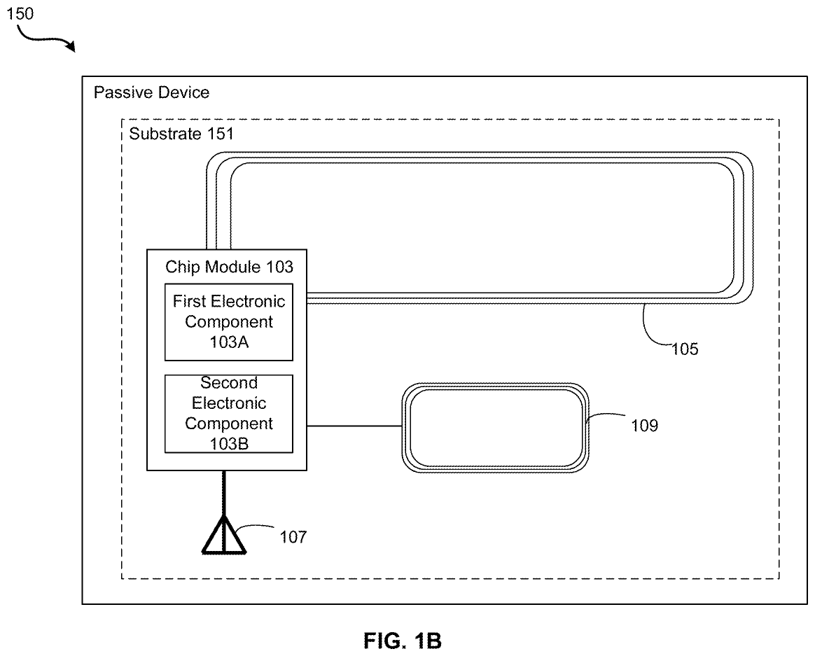

Having briefly described UWB and time of flight based ranging methods, embodiments of the present disclosure can now be described in more detail. FIG. 1A shows an exemplary passive device according to some embodiments. The passive device 100 may correspond to a contactless card e.g., an EMV (Europay, MasterCard, Visa) contactless card, an NFC tag, etc. As shown in FIG. 1A, the passive device 100 includes a substrate 101, which has a chip module 103, and a power antenna 105 disposed thereon. The chip module 103 houses a first electronic component 103A and a second electronic component 103B. The substrate 101 can be a planar plastic body, or it can be a plastic housing of some sort.

The power antenna 105 may be an NFC power antenna that is utilized for harvesting power for both, the first electronic component 103A and the second electronic component 103B. By some embodiments, the power antenna 105 harvests power from a radio frequency (RF) field of an access device (e.g., an NFC contactless terminal such as a POS terminal) with which the passive device 100 interacts e.g., passive device 100 is disposed in a vicinity of the access device. Specifically, the power antenna (i.e., a first antenna) is adapted to receive NFC signal (i.e., a first signal) emitted by the access device, to power at least the second electronic component. It is appreciated that as NFC communications occur in a first frequency range i.e., a few tens of megahertz (approximately 10 to 13.56 MHz), the power antenna 105 is arranged to be energized at such a frequency range.

By some embodiments, the first electronic component 103A is an NFC chip, and the second electronic component 103B is a UWB chip. The first electronic component 103A can be utilized to transmit transaction data, user identification data e.g., stored biometric data etc., to the access device. The communication performed by the first electronic component 103A can be via NFC contactless communication. The second electronic component 103B i.e., the UWB chip can be utilized to communicate with the access device using UWB protocol and measure a distance between the passive device 100 and the access device. The communication performed by the second electronic component 103B can occur using UWB protocol where transmission of data can occur in the form of UWB frames (occurring in a second frequency range of a few gigahertz e.g., 3-6 GHz) that are transmitted using a dedicated UWB communication antenna 107. In other words, upon the second electronic component 103B being powered, it emits a second signal (i.e., a signal including the UWB frames) that is received by the access device. Furthermore, it is noted that the second frequency range is greater than the first frequency range.

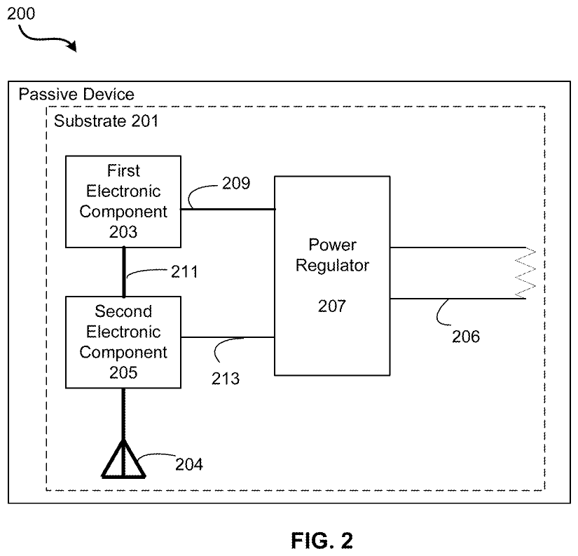

It is noted that a single power antenna i.e., antenna 105 is used to power both, the first electronic component 103A and the second electronic component 103B. By some embodiments, the first electronic component 103A regulates and controls the powering of the second electronic component. Details pertaining to the power regulation performed by the first electronic component 103A are described with reference to FIG. 2.

FIG. 1B shows another exemplary passive device according to some embodiments. The passive device 150 as shown in FIG. 1B includes a substrate 151 on which is deployed the chip module 103, a first power antenna 105, a second power antenna 109, and a communication antenna 107. The operation(s) of the chip module 103 is similar to that as described previously with reference to FIG. 1A. In the exemplary passive device 150 of FIG. 1B, the first power antenna 105 is configured to power only the first electronic component 103A, whereas the second power antenna 109 is configured to power the second electronic component 103B. Thus, in contrast to the embodiment illustrated in FIG. 1A, in the present embodiment, the first electronic component 103A and the second electronic component 103B are powered via dedicated antennas i.e., antennas 105 and 109, respectively.

It is appreciated that the exemplary block diagrams of the passive device illustrated in FIGS. 1A and 1B are for illustrative purposes and are in no way limiting the scope of the present disclosure. Other arrangements of the components illustrated in FIGS. 1A and 1B are well within the scope of the present disclosure. For instance, rather than having a single chip module e.g., chip module 103, house the first electronic component and the second electronic component, the electronic components can be house is separate chip modules. Further, the first electronic component 103A and the second electronic component may be included on separate substrates, and may be powered via a common power antenna or separate dedicated power antennas.

FIG. 2 shows a block diagram of a passive device according to some embodiments. The passive device 200 includes a substrate 201. The substrate 201 can have on it a first electronic component (e.g., an NFC chip) 203, a second electronic component (e.g., a UWB chip) 205, a communication antenna 204 that is associated with the second electronic component 205, a power regulator 207, and an antenna 206.

The passive device 200 interacts with an access device (e.g., a POS terminal) to conduct a transaction (e.g., a payment transaction, a secure access transaction, etc.). In processing a transaction, the first electronic component 203 can be utilized to transmit transaction data, user identification data e.g., stored biometric data etc., to the access device, whereas the second electronic component (i.e., the UWB chip) may be utilized to perform distance measurements between the passive device 200 and the access device. As shown in FIG. 2, a shared antenna (i.e., power antenna 206) is used to power each of the first electronic component 203 and the second electronic component 205. The power antenna 206 is directly coupled to the power regulator 207. The power regulator 207 is programmed to maintain, for instance, a voltage level and/or current level of the first electronic component 203 and the second electronic component 205 within acceptable (i.e., operational) limits.

According to some embodiments, the first electronic component 203, and the second electronic component 205 are powered via the antenna 206, when the passive device 200 is disposed in close proximity of an access device. Specifically, the antenna 206 harvests powers from an RF field of the access device when the passive device 200 is in close proximity of the access device. In this manner, the first electronic component 203, and the second electronic component 205 are powered (via the antenna 206) without the requirement of a battery to be included in the passive device 200.

By some embodiments, the first electronic component (i.e., the NFC chip) 203 is programmed to control and regulate power consumption of the second electronic component (i.e., the UWB chip) 205. For example, the first electronic component 203 controls and regulates power to the second electronic component 205 via a first link (connecting the first electronic component to the power regulator) or via a second link (connecting the first electronic component to the second electronic component). Specifically, the first electronic component 203 manages power consumption of the second electronic component 205 via a direct data link 211 (i.e., the second link) connecting the first and second electronic components. In another instance, the first electronic component 203 manages and controls power consumption of the second electronic component via a power control link 209 (i.e., the first link) that connects the first electronic component 203 to the power regulator 207. In this case, the first electronic component 203, controls the power regulator 207 to distribute, via a control link 213 (connecting the power regulator 207 to the second electronic component 205), a certain amount of power (at certain time instances) to the second electronic component 205. Details pertaining to the time instances and the power states of the first electronic component 203 and the second electronic component 205 are described next.

By some embodiments, the first electronic component 203 and the second electronic component 205 need different levels of power at different operating states. For instance, with respect to the second electronic component (i.e., the UWB chip), a minimal amount of power is required in a low power state, while higher level of power is required at transmission or reception state. With respect to the first electronic component (i.e., the NFC chip) 203, a high level of power is required when the first electronic component utilizes cryptographic modules which conducting transactions with an access device. It is appreciated that the states and the power consumption of the first electronic component 203 and the second electronic component 205 are designed by manufacturers. For sake of simplicity two power states can be assumed for each of the first electronic component 203 and the second electronic component 205:
First Electronic Component (203): (i) a low power state in which the first electronic component keeps an ongoing transaction alive be transmitting wait requests (i.e., requests for extensions of time) to the access device. It is noted that in this state a small amount of power is required by the first electronic component to transmit the wait requests. (ii) a high power state in which the first electronic component continues transaction with the access device including cryptographic computations if required.
Second Electronic Component (205): (i) a low power state in which the second electronic component has a small amount of power that is required to receive a trigger signal from the first electronic component e.g., a trigger signal transmitted via the direct data link 211. It is noted that in the low power state, the second electronic component does not transmit or receive any other information. (ii) a high power state where the second electronic component has a sufficiently high level of power to enable transmission and reception of data e.g., UWB data frames pertaining to distance computations between the passive device and the access device.

Thus, in operation, upon the passive device 200 being disposed in a close proximity of the access device, the antenna 206 of the passive device commences harvesting power via the RF field of the access device. As stated previously, the first electronic component 203 (e.g., the NFC chip) controls power consumption of the second electronic component 205. Thus, when the passive device receives power via the antenna 206, the first electronic component is powered to the high power state, while maintaining the second electronic component in a low power state. As the first electronic component is powered, the first electronic component 203 commences a transaction with the access device (e.g., a payment transaction), while the second electronic component is maintained in the low power state. Further, the first electronic component may generate a key and share the same with the access device (e.g., through a secure key exchange mechanism such as Diffie-Hellman. It is appreciated that the key can be used to secure (i.e., encrypt) distance computations performed by the second electronic component.

Upon sharing the key with the access device, the first electronic component 203 triggers (e.g., via the direct data link), the second electronic component 205 and provides an instruction (e.g., via controlling the power regulator 207) to power up the second electronic component to the high power state. In doing so, the second electronic component may receive the key from the first electronic component. Upon the second electronic component receiving the key, the first electronic component is maintained at the low power state, whist the second electronic component is in the high power state and ready for commencing distance computations between the access device and the passive device e.g., transmitting UWB frames from the passive device to the access device via the communication antenna 204.

It is appreciated that the embodiment of FIG. 2 is for illustrative purposes only and is in no way limiting the scope of the present disclosure. Other arrangements of the components illustrated in FIG. 2 are well within the scope of the present disclosure. For instance, the first electronic component 203 and the second electronic component may be included in separate substrates of the passive device 200. Further, the first electronic component and the second electronic component may be powered via dedicated antennas and/or power regulators. However, it is appreciated that in this case as well, the first electronic component 203 controls and regulates the power consumption of the second electronic component 205 via techniques as described above.

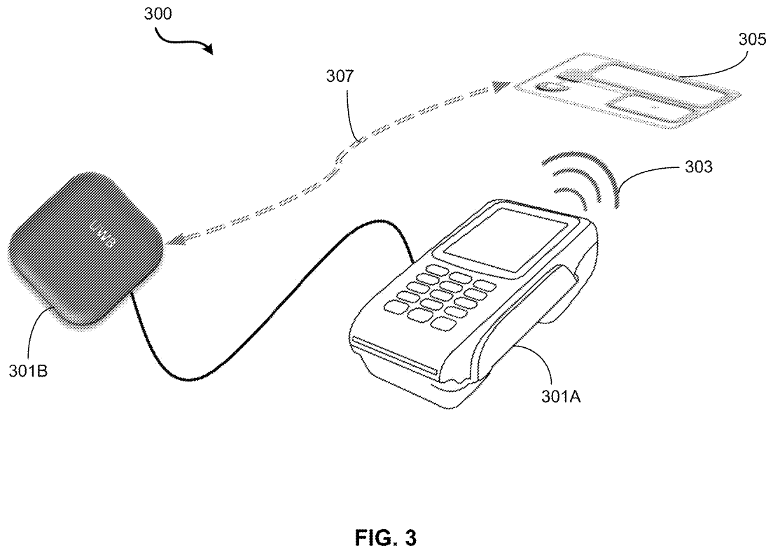

FIG. 3 depicts a system diagram illustrating interactions between a passive device and an access device according to some embodiments. The system 300 includes a passive device 305 (e.g., passive device 100, 150, or 200) that communicates with an access device 301A to process a transaction. The access device 301A may correspond to a POS terminal and may be indifferent shapes or forms including mobile phones.

As the access device 301A is involved in distance computations (i.e., distance measurements between the passive device and the access device), it is appreciated that the access device 301A is to be configured with a UWB chip. By one embodiment, as shown in FIG. 3, the access device 301A includes a dongle 301B that includes a UWB chip. As such, the combination of the access device 301A and the dongle 301B can be characterized as a UWB enabled access device. Alternatively, the access device 301A may include a UWB chip integrated within the access device. Further, as shown in FIG. 3, the passive device 305 is powered via an RF field 303 of the access device, when the passive device 305 is held in close proximity of the access device 301A. It is appreciated that the access device can utilize the RF field 303 to communicate transaction data (e.g., payment data) with the passive device 305.

The dongle 301B including the UWB chip can communicate with a corresponding UWB chip included in the passive device (e.g., the second electronic component of the passive device) via a UWB RF link 307 that is established between the dongle and a UWB communication antenna (e.g., antenna 204) included in the passive device. It is appreciated that the distance measurements performed by the passive device and/or the UWB enabled access device (i.e., the dongle) exchange data e.g., UWB frames over the UWB RF link 307. Furthermore, it is noted that information pertaining to transaction data that is exchanged between the passive device and the access device via the RF link 303, uses using a first wireless communication protocol e.g., NFC protocol in a first frequency range, whereas information pertaining to data related to distance measurements is exchanged over the UWB RF link 307 using a second wireless communication protocol e.g., UWB protocol in a second frequency range that is different than the first frequency range.

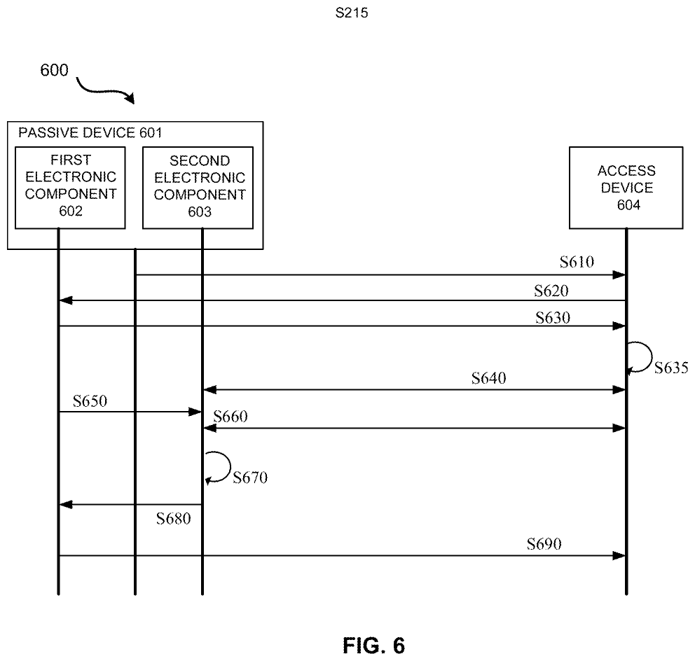

By some embodiments, a measurement of the distance between the access device and the passive device can be performed by either the access device only, by the passive device only, or it can be performed by both the access device and the passive device. In the case, where only the access device performs the distance measurement, the distance measurement can be performed immediately after the transaction is completed. It is noted that a UWB session key may be shared in encrypted form during the transaction. The access device analysis the measured distance to determine occurrence of a relay attack. In the scenario where both the access device and the passive device are involved in distance measurements, the ranging process (i.e., distance measurements) can be performed during the transaction (i.e., after session keys shared). During the distance measurement (i.e., at some point in the transaction), the passive device can transmit wait requests to the access device to keep the transaction alive. A detailed description illustrating the interactions between the components of the system 300 is described here with reference to FIG. 6.

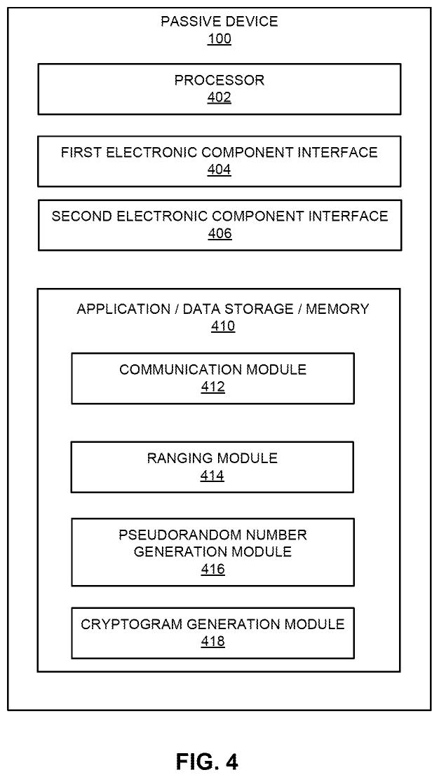

Turning to FIG. 4, there is depicted an exemplary passive device 100. FIG. 4 depicts a block diagram illustrating components included in a passive device according to some embodiments. As noted, passive device 100 may correspond to a contactless card (e.g., credit card or debit card, an access card i.e., an identification card for secure access, an NFC tag, etc.), which is programmed to interact with an access device to conduct a transaction (e.g., a payment transaction, an access transaction, etc.). In other embodiments, the passive device may take other form factors including a wrist band, a key fob, a badge, etc.

The passive device 100 may include circuitry that is used to enable certain functions, such as wireless communications. The functional elements responsible for enabling those functions may include a processor 402 that can execute instructions that implement the functions and operations of the passive device. Processor 402 may access data storage 410 (or another suitable memory region or element) to retrieve instructions or data used in executing the instructions.

The passive device 100 may also comprise a plurality of communications interfaces. For instance, the passive device 100 may include a first electronic component interface 404 and a second electronic component interface 406. Such communications interfaces may be used to enable data transmission between the passive device 100 and other devices (such as an access device, and/or devices that are part of a network such as the Internet or a cellular communication network. Each of the first electronic component interface 404 and the second electronic component interface 406 may include any number of hardware components that enable communication according to any number of appropriate communication protocols. For instance, the first electronic component interface 404 may correspond to a near field communication (NFC) contactless element interface that enables data transfer between a first electronic element e.g., NFC chip and an access device. It is appreciated that communication between the first electronic component of the passive device and the access device may be conducted via a short range communication technology e.g., NFC contactless communication occurring in a first frequency range of a few megahertz e.g., 13.56 MHz.

By some embodiments, the second electronic component interface 406 may correspond to a UWB communication interface. For example, the second electronic component interface 406 may include a UWB integrated circuit i.e., an UWB chip that enables the passive device to transmit and receive UWB frames. It is noted that communication between the passive device 100 and another device (e.g., access device) via the second electronic component i.e., a UWB chip, occurs at frequency levels that are different than frequency levels used for NFC communication. For example, UWB communication between the passive device and the access device can occur at a second frequency range of a few gigahertz e.g. 2-10 GHz. It is appreciated that the passive device 100 may further include hardware components to enable the passive device to conduct communications via Bluetooth®.

Data storage 410 may comprise a computer readable medium that may comprise a number of software modules, such as a communication module 412, a ranging module 414, a pseudorandom number generation module 416, and a cryptogram generation module 418.

Communication module 412 may comprise code enabling the processor 402 to implement or enable communications between the passive device 100 and other devices, such as an access device, as well as networks such as a cellular network or the Internet. For example, the passive device 100 can use the communication device to receive and store random identifiers, as well as allow communication according to any appropriate protocol, such as TCP, UDP, IS-IS, OSPF, IGRP, EIGRP, RIP, BGP, etc. The communication module 412 may allow secure communication by enabling the processor 402 to establish a secure or encrypted communication channel between the passive device 100 and other devices. For example, the communication module 412 may comprise code, executable by processor 402 for performing a key exchange (such as a Diffie-Hellman key exchange) between passive device 100 and other devices.

Ranging module 414 may comprise code or instructions, executable by the processor 402 for generating distance measurements, using, for example, a double-sided two-way ranging procedure in conjunction with an access device. Ranging module 414 may enable the passive device 100 to generate a distance measurement corresponding to the distance between the passive device 200 and an access device based on time of flight measurements.

Pseudorandom number generation module 416 may comprise code or instructions, executable by the processor 402 for generating random or pseudorandom numbers, including random identifiers such as UWB session identifiers. Cryptogram generation module 418 may comprise code or instructions, executable by the processor 402 for generating cryptograms using any appropriate method. For example, the passive device 200 can generate cryptograms by encrypting random identifiers, distance measurements, and the like using a symmetric or asymmetric cryptographic key.

It should be understood that although FIG. 4 displays an exemplary passive device 100 comprising software modules stored on a memory element 410, a passive device could implement some of the UWB functions described herein using hardware such as a single chip UWB transceiver (which may be part of the second electronic component interface 406), instead of or in addition to software modules 414 and 416. For example, a UWB transceiver chip can be used to generate distance measurements using time of flight based ranging procedures instead of using ranging module 414.

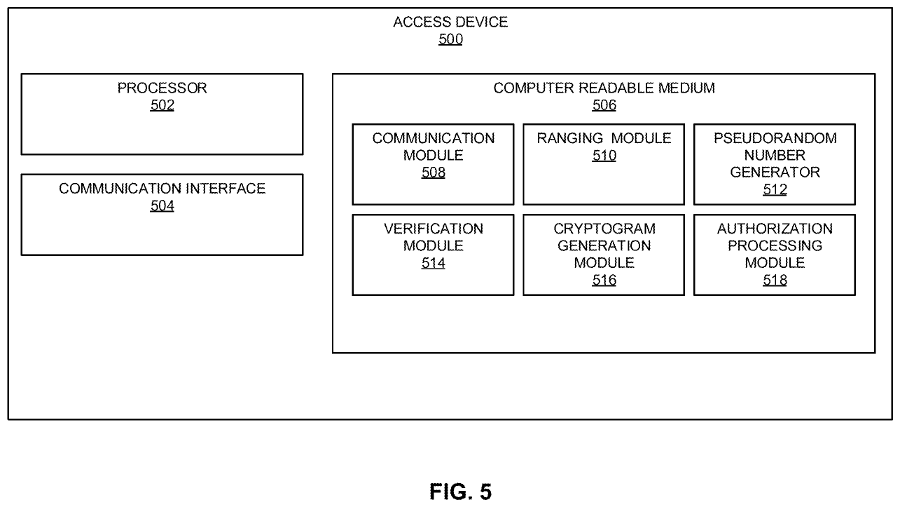

Turning to FIG. 5, there is depicted a system block diagram of an exemplary access device e.g., a POS terminal 500 comprising a processor 502, a communication interface 504 and a computer readable medium 506, comprising or storing a number of software modules, including a communication module 508, a ranging module 510, a pseudorandom number generator 512, a verification module 514, a cryptogram generation module 516, and an authorization processing module 518.

Processor 502 may comprise any suitable data computation device or devices. Processor 502 may be able to interpret code and carry out instructions stored on computer readable medium 506. Processor 502 may comprise a Central Processing Unit (CPU) operating on a reduced instructional set, and may comprise a single or multi-core processor, or any other appropriate processing unit. Processor 502 may also include an Arithmetic Logic Unit (ALU) and a cache memory.

Communication interface 504 may comprise any interface by which the access device 500 can communicate with other computers or devices e.g., the passive device 100 of FIG. 4. Examples of communication interfaces include wired interfaces, such as USB, Ethernet, or FireWire, as well as wireless interfaces such as Bluetooth®, Wi-Fi, NFC transceivers or UWB transceivers (including for example, a UWB transceiver integrated circuit (IC)). Access device 500 can possess multiple communication interfaces 504. As an example, access device may communicate with a passive device via a Bluetooth® transceiver, an NFC transceiver, or a UWB transceiver and a processing network computer via an Ethernet interface.

Communication module 508 may comprise code, software or instructions that may be interpreted and executed by processor 502. This software may be used by access device 500 in order to communicate with other devices, such as the passive device 100 of FIG. 4. The communication module 508 may include code or instructions for receiving and interpreting messages or other transmissions from passive devices, including UWB frames. Communication module 508 may enable access device 500 to communicate with other computers and devices according to any appropriate communication protocol.

Ranging module 510 may comprise code or instructions, executable by the processor 502 for performing functions associated with determining distance measurements. For example, the ranging module 510 may comprise code enabling the access device 500 to perform a double-sided two-way ranging procedure with a passive device e.g., passive device 100 of FIG. 4. Pseudorandom number generator 512 may comprise code or instructions, executable by processor 502 for generating random and pseudorandom numbers using any appropriate method or algorithm. These random or pseudorandom numbers can include for instance, UWB session numbers that can be generated for each instance of a distance measurement between the access device and the passive device.

Verification module 514 may comprise code or instructions, executable by processor 502 for verifying cryptograms or other data received from passive devices. Verification module 514 can also be used to compare a distance measurement to a predetermined distance threshold, in order to verify that a passive device is present during a data transfer. According to some embodiments, the verification module 514 may be programmed to compare a distance measurement performed by the passive device (e.g., a first distance measurement between the passive device and the access device) to a distance measurement performed by the access device 500 (e.g., a second distance measurement between the passive device and the access device). Based on the comparison, the access device may determine a risk of a relay attack. For instance, if a difference between the first and second distance measurements exceeds a threshold, then the access device 500 may successfully identify a presence of a relay attack.

Cryptogram generation module 516 may comprise code or instructions, executable by the processor 502 for generating cryptograms using any appropriate method. For example, the access device 500 can generate cryptograms by encrypting random identifiers, distance measurements, and the like using a symmetric or asymmetric cryptographic key.

Authorization processing module 518 may comprise code or instructions, executable by processor 502 for authorizing some interaction based on a data transfer between the passive device and the access device. For example, If the access device 500 comprises a system used to control access to a secure building, the authorization processing module 518 may comprise code used to, for example, verify a credential used to access the secure building and/or to transmit signals unlocking a door to the secure building based on results of distance computations performed by the verification module 514. In another instance, e.g., in a transaction based system, the authorization processing module 518 may comprise code or instructions, executable by processor 502 for generating and transmitting authorization request messages, and receiving and interpreting authorization response messages.

FIG. 6 shows a sequence diagram illustrating interactions between a passive device and an access device according to some embodiments. As described previously, the passive device 601 (e.g., a contactless card) includes a first electronic component (e.g., a NFC chip) 602, and a second electronic component (e.g., a UWB chip) 603.

The process commences in step S610, where the passive device 601 is disposed in a close proximity of the access device 604. As such, the passive device 601 enters an RF field of the access device 604. In step 620, the first electronic component 602 of the passive device 601 is powered. It is appreciated that the second electronic component 603 of the passive device 601 is maintained in a low power state.

In step 630, the first electronic component 602 commences a transaction (e.g., a payment transaction, an access transaction, etc.) with the access device 604. Transaction related data is transferred from the first electronic component 602 to the access device 604. As the transaction requires relay attack prevention measures, the first electronic component 602 may request a distance measurement to be performed by either the access device 604, or by both, the access device 604 and the second electronic component 603. In order to ensure security of the distance measurements, the first electronic component 602 may generate a key and share the key with the access device 604 in step S630.

According to some embodiments, in cases where only the access device 604 is programmed to perform distance measurements, the access device 604 may utilize the key (generated by the first electronic component 602 in step S630) to secure (i.e., encrypt) the distance measurements. Alternatively, by some embodiments, the access device 604 may also generate a key to secure the distance measurement (step S635). In step S640, the access device 604 performs distance measurement with respect to the passive device 601 using time of flight (ToF) measurements. The distance measurement performed by the access device 604 may be shared with the second electronic component 603 of the passive device 601.

In cases where only the access device 604 is programmed to perform the distance measurements, the process after step S640 proceeds to step S670. However, if the second electronic component 603 is also programmed to perform distance measurements, the process moves to step S650. In step S650, the first electronic component 602 activates the second electronic component and shares the key generated in step S630 with the second electronic component 603. The process then moves to step S660, where the second electronic component 603 performs distance measurement with respect to the access device 604 using time of flight (ToF) measurements. It is noted that this distance measurement may be secured based on the key obtained by the second electronic component in step S650.

In step S670, the distance measurement performed by the access device (of step S640) is compared to a threshold distance. If the measured distance is below the threshold distance, the passive device may successfully determine an absence of relay attacks. However, if the measured distance is greater than the threshold distance, the passive device may successfully determine the presence of a relay attack. It is noted that in cases, where both the second electronic component 603 and the access device 604 perform distance measurements, the passive device may determine the presence/absence of a relay attack based on both measurements, For example, the second electronic component may compute a difference between a first distance measurement (performed by the access device) and a second distance measurement (performed by the second electronic component). If the computed difference is greater than a threshold distance, the passive device can successfully determine a presence of a relay attack. However, if the computed difference is lower than the threshold distance, the passive device can successfully determine an absence of a relay attack. It is appreciated that although in the above described embodiment, the second electronic component 604 performs analysis of the distance measurements, such an analysis can also be performed by the access device 604, where after results of the analysis may be transmitted by the access device to the passive device.

In step S680, the second electronic component 603 notifies the first electronic component 602 regarding the results of the analysis of the distance measurements. Based on the absence of relay attacks, the first electronic component 602 completes the transaction with respect to the access device (step S690). In contrast, in the case of successfully determining the presence of a relay attack, the first electronic component 602 cancels the transaction with the access device 604, and may optionally transmit a message to the access device 604 indicating the canceling of the transaction in step S690.

Embodiments of the invention have a number of advantages. In embodiments of the invention, a second electronic component that communicates in one protocol can be trigged by a first electronic component that communicates in another protocol, and both components may be powered by power from a same antenna from an external access device. This provides for an elegant design solution whereby a single power source can provide power to the second component and the output of the second electronic component can be controlled by the first electronic component. As such, separate power sources are not needed for both the first and second electronic components, even through they process signals using different protocols. Further, some embodiments of the invention can incorporate the use of NFC and UWB chips, and UWB chips can be used in access transactions to prevent relay attacks. Only minor modifications are needed to existing passive devices and access devices that only have NFC chips to achieve the benefits of embodiments of the invention.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

1. A passive device comprising:
a substrate;
a first electronic component on the substrate, the first electronic component programmed to communicate with an access device using a first wireless communication protocol in a first frequency range;
a second electronic component on the substrate programmed to communicate with the access device using a second wireless communication protocol in a second frequency range different than the first frequency range;
a first antenna electrically coupled to at least the first electronic component or the second electronic component; and
a second antenna electrically coupled to at least the second electronic component,
wherein the first antenna is adapted to receive a first signal from the access device, which powers at least the second electronic component, thereby causing the second electronic component to cause the second antenna to emit a second signal that is received by the access device.

2. The passive device of claim 1, wherein the passive device is a contactless card.

3. The passive device of claim 1, wherein the first wireless communication protocol is an NFC protocol and the second wireless communication protocol is an ultra-wide band (UWB) protocol.

4. The passive device of claim 1, wherein the first electronic component is an NFC chip and the second electronic component is a ultra-wide band (UWB) chip.

5. The passive device of claim 4, wherein the NFC chip and the UWB chip are in a same chip module.

6. The passive device of claim 1, wherein the second electronic component is programmed to measure a distance between the passive device and the access device based on the second signal.

7. The passive device of claim 6, wherein the first electronic component is programmed to commence an authorization process based on the distance being less than a threshold distance.

8. The passive device of claim 1, wherein the second frequency range is greater than the first frequency range.

9. The passive device of claim 1, further comprising a power regulator, wherein the first electronic component is electrically coupled to the power regulator via a first link, the power regulator supplying power to the first electronic component via the first link.

10. The passive device of claim 1, wherein the first electronic component is coupled to the second electronic component via a second link, and wherein the first electronic component is programmed to power the second electronic component via the second link.

11. The passive device of claim 9, wherein the first antenna is directly coupled to the power regulator.

12. The passive device of claim 1, wherein the first signal is an RF signal emitted by the access device.

13. A method involving a passive device, the passive device comprising a first electronic component and a second electronic component on a substrate, a first antenna electrically coupled to at least the first electronic component or the second electronic component, and a second antenna electrically coupled to at least the second electronic component, the method comprising:
communicating, by the first electronic component, with an access device using a first wireless communication protocol in a first frequency range;
triggering by the first electronic component, the second electronic component of the passive device to communicate with the access device using a second wireless communication protocol in a second frequency range, the second frequency range being different than the first frequency range;
receiving, by the first antenna, a first signal from the access device, the first signal powering at least the second electronic component; and
causing, the second electronic component to cause the second antenna to emit a second signal that is received by the access device.

14. The method of claim 13, wherein the passive device is a contactless card, and wherein the first wireless communication protocol is an NFC protocol and the second wireless communication protocol is an ultra-wide band (UWB) protocol.

15. The method of claim 13, wherein the first electronic component is an NFC chip and the second electronic component is a ultra-wide band (UWB) chip, the NFC chip and the UWB chip being included in a same chip module.

16. The method of claim 13, further comprising:
calculating, by the second electronic component, a distance between the passive device and the access device based on the second signal.

17. The method of claim 13, further comprising:
receiving, by the first electronic component, a power supply from a power regulator via a first link coupling the first electronic component to the power regulator; and
powering, by the first electronic component, the second electronic component via a second link coupling the first electronic component to the second electronic component.

18. A method conducting by an access device that communicates with a passive device, the passive device comprising passive device comprising a substrate, a first electronic component on the substrate, a second electronic component on the substrate, a first antenna electrically coupled to at least the first electronic component or the second electronic component; and a second antenna electrically coupled to at least the second electronic component, the method comprising:
transmitting, by the access device to the first antenna of the passive device, a first signal in a first wireless communications protocol, which powers at least the second electronic component, thereby causing the second electronic component to cause the second antenna to emit a second signal in a second wireless communications protocol; and
receiving, by the access device, the second signal in the second wireless communications protocol.

19. The method of claim 18, wherein the first wireless communication protocol uses NFC and the second wireless communications protocol uses UWB.

20. The method of claim 18, wherein the first electronic component is an NFC chip and the second electronic component is an ultra-wide band (UWB) chip.
